(19) United States
(12) Patent Application Publication
(10) Pub. No.: US 2026/0361167 A1
(43) Pub. Date: Nov. 12, 2026

(54) STATOR OF AN ELECTRIC MACHINE

(71) Applicant: Robert Bosch GmbH, Stuttgart (DE)

(72) Inventors: Daniel Kuehbacher, Stuttgart (DE); Felix Bensing, Stuttgart (DE); Jannik Stammler, Stuttgart (DE); Johannes Riedl, Bergheim (DE)

(21) Appl. No.: 19/125,081

(22) PCT Filed: Oct. 4, 2023
(86) PCT No.: PCT/EP2023/077389

§ 371 Date: Apr. 28, 2025

(30) Foreign Application Priority Data
Oct. 28, 2022 (DE) 10 2022 211 493.0

(51) Int. Cl. H02K 3/24

(52) U.S. Cl. CPC H02K 3/24

(57) ABSTRACT

The invention relates to a stator (1) of an electric machine (2) with a stator laminated core (4), on which stator teeth (5) and stator slots (6) are formed and which comprises a plurality of laminations (7), wherein the stator slots (6) each extend in the radial direction between a slot base (6g) and a slot head (6h), wherein a conductor bundle (9) is provided in each of the stator slots to form an electric stator winding (10) (6), wherein several support points (11) are formed in each of the stator slots (6) to clamp the respective conductor bundle (9), wherein at least one slot gap (12) is provided between the slot flanks (6f) and the conductor bundle (9) arranged in the stator slot (6) that forms a slot gap channel (13), through which a cooling medium can flow along a slot cooling path (14), characterized in that—the support points (11) are each formed by twisting individual or multiple laminations (7) of the stator laminated core (4),—at least one supply path (22) is formed in the stator laminated core (4), that in each case opens into the stator slots (6) via a slot inlet (23),—two slot cooling paths (14) extending in opposite directions are provided in each stator slot (6) starting from the respective slot inlet (23), which exit as a free jet via a slot outlet (24) at the ends of the respective stator slot (6).

### BACKGROUND

The invention proceeds from a stator of an electric machine of the type specified in the disclosure.

A stator of an electric machine is already known from DE102019113785 A1, with a stator axis and a stator laminated core on which stator teeth and stator slots lying between the stator teeth are formed and which comprises a plurality of laminations, wherein the stator slots each extend in the radial direction with respect to the slot axis between a slot base and a slot head, wherein a conductor bundle comprising an individual conductor or multiple conductors, in particular a stack of flat wire conductors, is provided in the stator slots to form an electric stator winding, wherein a plurality of support points which are spaced apart from each other in the axial direction with respect to the stator axis are formed in each stator slot to clamp the conductor or conductor bundle lying in the respective stator slot, wherein at least one slot gap is provided between the flanks of the respective stator slot and the conductor or conductor bundle arranged in the stator slot, said slot gap forming a slot gap channel extending in the axial direction, through which a cooling medium can flow along a slot cooling path. The support points are each formed on a special lamella of the laminated core, referred to as a clamping stator lamination, in that a clamping contour comprising a plurality of clamping projections is provided in each case. The special lamellas differ from the other laminations of the laminated core. The conductor bundles must each be inserted into the stator slots in the axial direction with respect to the stator axis and moved through the clamping contours under the effect of clamping forces.

This can damage the conductor bundles, especially their electrical insulation.

An electric machine is known from DE102018101640 A1 in which a stator space is sealed against a rotor space by means of a slotted tube.

### SUMMARY

In contrast, the stator according to the invention has the advantage that the support points can be generated without special lamellas and the conductor bundles can be inserted into the stator slots during assembly without clamping forces. In this way, the manufacturing costs of the stator are reduced. It also prevents damage to the conductor bundles when they are inserted into the respective stator slots.

According to the invention, this is achieved by forming the support points in each case by twisting individual or a plurality of laminations of the laminated core, in particular one group or several groups of laminations.

The stator according to the invention further has the advantage that the cooling path in the stator is simplified with regard to the flow connection of the slot gap channels or the slot cooling paths. The slot cooling paths are part of a direct conductor cooling system. In particular, no ring distributor is required on the end faces of the stator laminated core to distribute the cooling medium into the slot gap channels and/or no ring collector is required to collect the cooling medium exiting the slot gap channels, which would require sealing a stator space against a rotor space of the electric machine, for example by means of a sleeve or a slotted tube. Furthermore, the flow connection of the slot gap channels according to the invention allows a lower pressure in the cooling path, reducing the requirements for sealing the slot gap channels. In addition, the pressure drop in the respective cooling path is reduced because the respective cooling path does not extend over the entire length but only over an axial section of the respective stator slot.

This is achieved according to the invention by forming at least one supply path in the stator laminated core, which is provided for supplying cooling medium to the slot cooling paths and opens into the stator slots via a slot inlet in each case, and by providing two slot cooling paths extending in opposite directions in the respective stator slot starting from the respective slot inlet, which exit at the ends of the respective stator slot via a slot outlet as a free jet, in particular in the slot head or in the slot base.

For example, at least some of the slot outlets are arranged so that the respective winding head of the stator winding is wetted by the respective free jet and thereby cooled. To further improve the winding head cooling, the respective winding head of the stator winding may additionally be sprayed with cooling fluid that is sprayed or splashed from a cooling channel of a rotor or housing of the electric machine.

According to an advantageous embodiment, it is provided that the respective slot cooling path is at least narrowed at the support points, wherein a bypass is provided at each support point to guide the cooling medium past the respective narrowed support point, wherein the bypasses of the respective stator slot are formed alternately in the slot base or in the slot head starting from the respective slot inlet along the respective slot cooling path, in particular to form meandering slot cooling paths. In this way, the cooling of the conductor or conductor bundle in the respective stator slot is improved.

It is also advantageous if the first bypasses of the respective stator slot, when viewed from the respective slot inlet in the flow direction, are provided in the slot head. In this way, a first meandering section is generated in the respective slot cooling path, thus improving the cooling of the conductor or conductor bundle.

It is very advantageous if the respective slot inlet opens into the slot base of the respective stator slot in a central axial section of the respective stator slot, particularly in the axial center. In this way, the conductor or the conductor bundle in the respective stator slot is cooled evenly along its axial extension.

Furthermore, it is advantageous if the respective slot inlet in the respective stator slot is between two support points, whose axial distance from each other is less than the distance from other adjacent support points. In this way, the conductors of a conductor bundle facing away from the slot base are better cooled in the area of the slot inlet.

According to a first flow guide variant, the same path of the slot cooling paths may be provided for all stator slots. Alternatively, according to a second flow guide variant, first slot cooling paths may be provided on the same stator for a first set of stator slots and second slot cooling paths extending in the opposite radial direction to the first slot cooling paths may be provided for a second set of stator slots. Radially opposing slot cooling paths extending in the same axial direction have radially opposing bypasses at the same axial support point, i.e., in the one slot cooling path in the slot base and in the other slot cooling path in the slot head.

According to the first flow guide variant, the two slot cooling paths extending in opposite directions for each stator slot can be supplied with cooling medium by means of a common slot inlet according to a first embodiment or by means of two separate slot inlets separated from each other by one of the support points according to a second embodiment. For example, the first embodiment may be provided for an even number of support points for each stator slot and the second embodiment for an odd number of support points for each stator slot.

According to the second flow guide variant, the first slot cooling paths of the first set of stator slots can be supplied with cooling medium via first slot inlets, and the second slot cooling paths of the second set of stator slots via second slot inlets. An axial offset, in particular a support point, is provided between the first and second slot inlets in the axial direction. In this way, opposing slot cooling paths are created in the stator in the radial direction.

It is particularly advantageous if the stator slots are closed by means of at least one slot closure to seal the slot cooling paths.

The stator slots may advantageously have slots in the slot head. According to a first slot closure variant, a strip-shaped slot closure, in particular a cover slider, can be provided as a separate element in each slot. Alternatively, as a second slot closure variant, a single sleeve-shaped or tubular slot closure can be designed as a separate element for closing all slots. In this way, the slot cooling paths are sealed off from the air gap to the greatest extent possible. An advantage in the case of the cover sliders is that they are not arranged in the air gap of the electric machine. Partially arranging the slot closure would disadvantageously increase the air gap.

According to a third slot closure variant, the slot closures can each be formed by a tooth head bridge that is part of one of the laminations, connects tooth heads of adjacent stator teeth, and in particular has a reduced magnetic conductivity. This has the advantage that the slot closure is achieved without an additional component and is also not arranged in the air gap of the electric machine.

It is also advantageous when the respective slot closure comprises multiple barriers spaced apart from each other in the axial direction for the respective slot cooling path, which in particular extend to the conductor or the conductor bundle, and that a passage as bypass for the respective slot cooling path is formed between adjacent barriers of the same stator slot. In this way, bypasses can be created in or at the slot closure for the flow around the support points according to the invention.

The respective bypass in the slot head can advantageously be formed by a recess in the slot closure that is recessed compared to adjacent barriers of the same stator slot, or alternatively by one or two recesses in the slot flanks at the foot of a tooth head of the stator teeth. The recess in the slot closure can be, for example, a cutout, shaping, or protrusion.

The respective bypass in the slot base can advantageously be formed by one or two recesses in the slot flanks at the foot of the stator teeth or by a recess in the slot base.

The invention further relates to an electric machine with a stator according to the invention and with a rotor, wherein the rotor is arranged in a cylindrical rotor space and the stator is arranged in a stator space annularly enclosing the rotor space. According to the invention, the stator space and the rotor space are not spatially separated from each other and thus not sealed against each other. As a result, the cooling medium, in particular a cooling fluid, of the slot cooling paths can be easily captured and collected in a sump.

A seal between the stator space and rotor space, for example by means of a so-called slotted tube, is not required, thus reducing the manufacturing costs of the electric machine. In particular, no ring distributor and/or ring collector is required on the end faces of the stator laminated core, which encloses one of the winding heads of the stator winding for its cooling, is sealed from the rotor space, and is provided for distributing the cooling medium into the slot gap channels or for collecting the cooling medium exiting the slot gap channels.

### BRIEF DESCRIPTION OF THE DRAWINGS

An exemplary embodiment of the invention is shown in simplified form in the drawing and explained in more detail in the following description.

Shown are:

FIG. 1 shows a partial view of a stator according to the invention of an electric machine,

FIG. 2 shows in section one of the stator slots of the stator in FIG. 1 with a conductor bundle supported at several support points according to the invention.

FIG. 3 shows a view of a support point according to the invention in FIG. 2.

FIG. 4 shows a first embodiment of the stator in FIG. 1 and FIG. 2 in section along a line IV-IV in FIG. 2 with slot cooling paths according to the invention, which have a common slot inlet,

FIG. 5 shows a second embodiment of the stator in FIG. 1 and FIG. 2 in section along a line IV-IV in FIG. 2 with slot cooling paths according to the invention, which have a common slot inlet,

FIG. 6 shows a third embodiment of the stator in FIG. 1 and FIG. 2 in section along a line IV-IV in FIG. 2 with slot cooling paths according to the invention, which have separate slot inlets,

FIG. 7 shows, according to a fourth embodiment, a stator slot of a first set of stator slots of the stator in FIG. 1 and FIG. 2 with slot cooling paths according to the invention, which have a common slot inlet,

FIG. 8 shows, according to the fourth embodiment, a stator slot of a second set of stator slots of the stator in FIG. 1 and FIG. 2 with slot cooling paths according to the invention, which have a common slot inlet,

FIG. 9A shows a section along the line IX-IX in FIG. 4 for an embodiment of the stator with a sleeve-shaped slot closure,

FIG. 9B shows a section along the line IX-IX in FIG. 4 for an embodiment of the stator with strip-shaped cover sliders as slot closures,

FIG. 9C shows a section along the line IX-IX in FIG. 4 for an embodiment of the stator with tooth head bridges as slot closures,

FIG. 10A shows a section along the line X-X in FIG. 4 for an embodiment of the stator with a sleeve-shaped slot closure,

FIG. 10B shows a section along the line X-X in FIG. 4 for an embodiment of the stator with strip-shaped cover sliders as slot closures,

FIG. 10C shows a section along the line IX-IX in FIG. 4 for an embodiment of the stator with tooth head bridges as slot closures,

FIG. 11A shows a section along the line XI-XI in FIG. 4 for an embodiment of the stator with a sleeve-shaped slot closure,

FIG. 11B shows a section along the line XI-XI in FIG. 4 for an embodiment of the stator with strip-shaped cover sliders as slot closures,

FIG. 11C shows a section along the line XI-XI in FIG. 4 for an embodiment of the stator with tooth head bridges as slot closures, and

FIG. 12 shows an electric machine comprising a stator and a rotor according to the invention.

### DETAILED DESCRIPTION

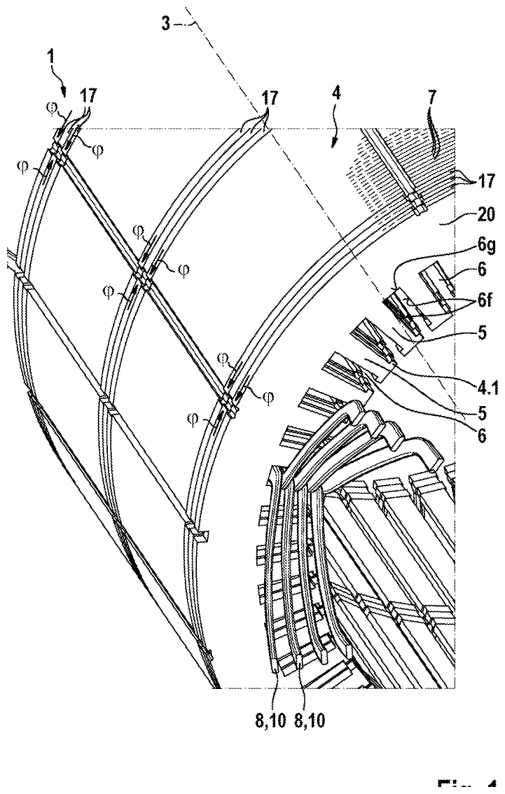

FIG. 1 shows a partial view of a stator according to the invention of an electric machine.

The stator 1 according to the invention of an electric machine 2 has a stator axis 3 and comprises a stator laminated core 4 on which the stator teeth 5 and stator slots 6 lying between the stator teeth 5 are formed and which comprises a plurality of laminations 7. The stator teeth 5 of the stator 1 are connected to each other via a stator yoke 20, for example. A conductor bundle 9 comprising an individual conductor 8 or a plurality of conductors 8, in particular a stack of flat wire conductors, is provided in each of the stator slots 6 to form an electric stator winding 10. A conductor bundle 9 is shown in only one of the stator slots 6 in FIG. 1 for ease of illustration. The respective conductor 8 has an enamel insulation (not shown).

The stator slots 6 each extend in the radial direction with respect to the stator axis 3 between a slot base 6g facing the stator yoke 20 and a slot opening 6h facing away from the slot base 6g. The slot head 6g refers to a radial part of the stator slot 6 facing away from the slot base 6g, which lies in the area of the radially innermost conductor 8 of the conductor bundle 9, for example, and can also include a slot opening 6s of the stator slot 6.

FIG. 2 shows a section of one of the stator slots of the stator according to FIG. 1 with a conductor bundle mounted on a plurality of support points according to the invention.

A plurality of support points 11 spaced apart from one another in the axial direction with respect to the stator axis 3 are formed in each of the stator slots 6 to clamp and hold the conductor 8 or conductor bundle 9 lying in the respective stator slot 6.

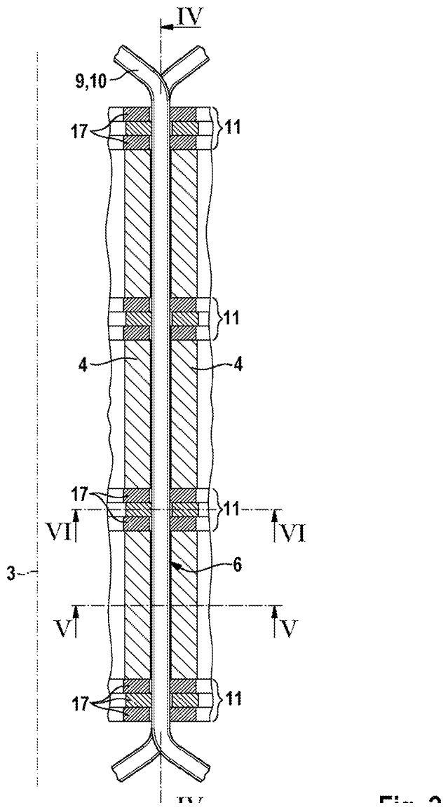

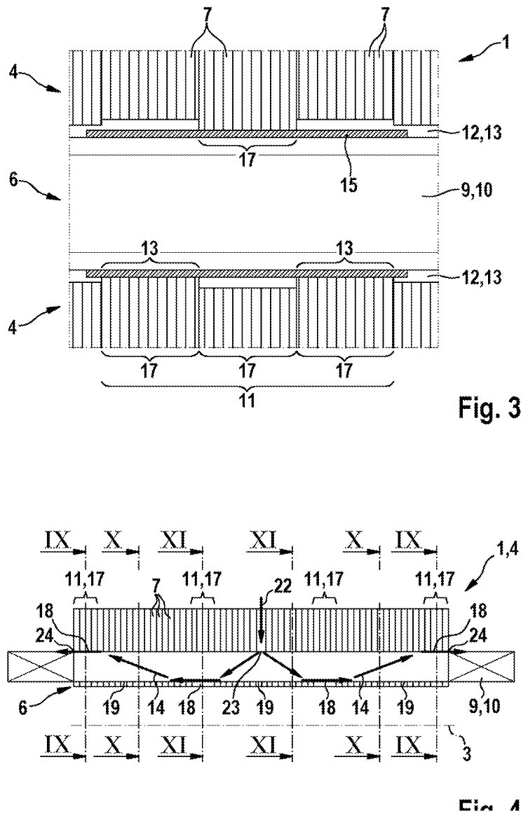

FIG. 3 shows a view of a support point according to the invention as shown in FIG. 2.

According to the invention, it is provided that the support points 11 are each formed by twisting individual or a plurality of laminations 7 of the stator laminated core 4, in particular a group 17 or a plurality of groups 17 of laminations 7.

To form a single one of the support points 11, the twisted laminations 7 are twisted relative to the other laminations 7 of the stator laminated core 4 about the stator axis 3 (in the opposite direction), for example by a certain twisting angle φ. In FIG. 3, for example, the respective support point 11 is formed by two groups 17 of laminations 7, which are twisted in opposite directions by the determined twisting angle o about the stator axis 3. Between the support points 11 according to the invention, the conductor 8 or the conductor bundle 9 of the respective stator slot 6 is freely suspended, i.e., without contact with the stator laminated core 4. The conductor 8 or the conductor bundle 9 of the respective stator slot 6 is thus in contact with the stator laminated core 4 only at the support points 11.

By twisting the laminations 7 in opposite directions to form the respective support point 11, support sections of the laminations 7 are formed, which project from opposite sides of the respective stator slot 6 into the respective stator slot 6 to clamp the conductor 8 or conductor bundle 9 between the support sections at clamping surfaces of the conductor 8 or conductor bundle 9. The conductor 8 or the conductor bundle 9 of the respective stator slot 6 can have at least one raised protective layer 15 at the clamping surfaces of the respective support point 11. The twisted laminations 7 are fixed in the stator laminated core 4 to prevent further twisting, for example by material-locking joining of laminations 7, in particular by welding.

Between the nut flanks 6f of each stator slot 6 and the conductor 8 or conductor bundle 9 arranged in the stator slot 6, there is at least one slot gap 12, which forms a slot gap channel 13 extending in the axial direction. The respective slot gap channel 13 can be flowed through by a cooling medium, which is particularly a cooling fluid, for example oil, along a slot cooling path 14 and is formed on both sides of the conductor 8 or conductor bundle 9 towards both slot flanks 6f.

FIG. 4 shows a first embodiment of the stator in FIG. 1 and FIG. 2 in section along a line IV-IV in FIG. 2 with slot cooling paths according to the invention, which have a common slot inlet.

Furthermore, according to the invention, it is provided that at least one supply path 22 is formed in the stator laminated core 4, which is provided for supplying cooling medium to the slot cooling paths 14 and opens into the stator slots 6 via a slot inlet 23 in each case. The respective supply path 22 extends in the stator laminated core 4 in the radial direction at least at an end facing the respective slot inlet 23.

According to the invention, two slot cooling paths 14 extending in opposite directions are provided in the respective stator slot 6 starting from the respective slot inlet 23, that exit as a free jet at the ends of the respective stator slot 6 via a slot outlet 24, in particular in the slot base 6g or in the slot head 6h.

The respective slot cooling path 14 is at least narrowed at the support points 11, wherein a bypass 18 is provided at each support point 11 in order to guide the cooling medium past the respective constricted support point 11. The bypasses 18 of the respective stator slot 6 are formed from the respective slot inlet 23 along the respective slot cooling path 14, alternating between the slot base 6g and the slot head 6h, whereby a meandering progression of the slot cooling paths 14 can be achieved.

The first bypasses 18 of the respective stator slot 6, when viewed from the respective slot inlet 23 in the flow direction, are provided in the slot top 6h, for example.

The respective slot inlet 23 opens into the slot base 6g of the respective stator slot 6 in a central axial section of the respective stator slot 6, in particular in the axial center.

According to the first embodiment of the stator 1, equal axial distances d are provided between adjacent support points 11, for example.

According to a first flow guide variant, the same path of the slot cooling paths 14 can be provided for all stator slots 6. Such an exemplary path is shown in FIG. 4.

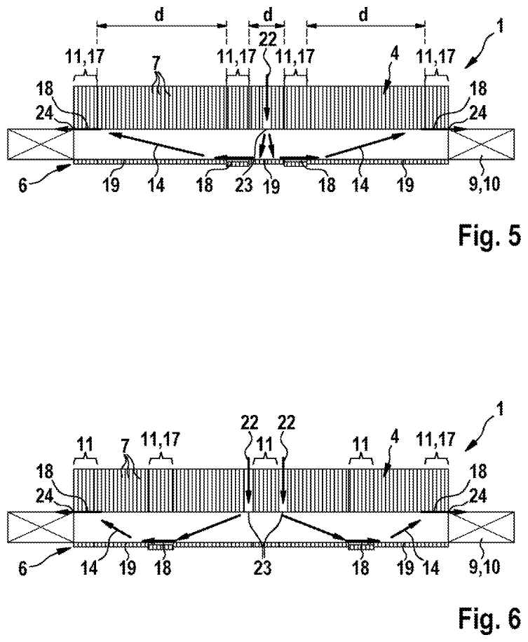

FIG. 5 shows a second embodiment of the stator in FIG. 1 and FIG. 2 in section along a line IV-IV in FIG. 2 with slot cooling paths according to the invention, which have a common slot inlet.

According to the second embodiment of the stator 1, the respective slot inlet 23 of the respective stator slot 6 lies between two support points 11, whose axial distance d from each other is smaller than the distance d between other adjacent support points 11.

FIG. 6 shows a third embodiment of the stator according to FIG. 1 and FIG. 2 in section along a line IV-IV in FIG. 2 with slot cooling paths according to the invention, which have separate slot inlets.

According to FIG. 4 and FIG. 5, slot cooling paths 14, which have a common slot inlet 23, are provided for each stator slot 6. Alternatively, slot cooling paths 14, which have separate slot inlets 23, may be configured for each stator slot 6. The separate slot inlets 23 are separated from one another by a support point 11, for example.

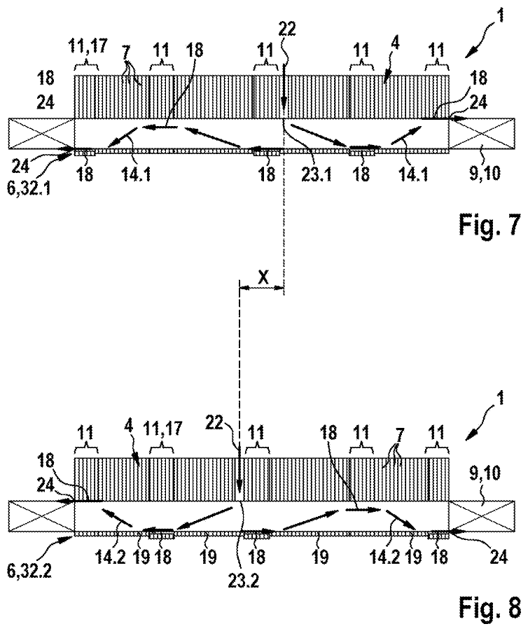

FIG. 7 shows, according to a fourth embodiment, a stator slot of a first set of stator slots of the stator according to FIG. 1 and FIG. 2 with slot cooling paths according to the invention, which have a common slot inlet.

FIG. 8 shows, according to the fourth embodiment, a stator slot of a second set of stator slots of the stator according to FIG. 1 and FIG. 2 with slot cooling paths according to the invention, which have a common slot inlet.

According to a second flow guide variant, first slot cooling paths 14.1 in FIG. 7 may be provided on the same stator 1 for a first set 32.1 of stator slots 6, and second slot cooling paths 14.2 according to FIG. 8, extending in the opposite radial direction, may be provided for a second set 32.2 of stator slots 6. Radially opposing slot cooling paths 14 extending in the same axial direction have radially opposing bypasses 18 at the same axial support point 11, i.e., in one slot cooling path 14.1, 14.2 in the slot base 6g and in the other slot cooling path 14.1, 14.2 in the slot head 6h. The radially opposite path of the slot cooling paths 14 is achieved by an axial offset X of the slot inlets 23.

Thus, the first slot cooling paths 14.1 of the first set 32.1 of stator slots 6 have first slot inlets 23.1, and the second slot cooling paths 14.2 of the second set 32.2 of stator slots 6 have second slot inlets 23.2. In the axial direction between the first and second slot inlets 23.1, 23.2, the axial offset X, in particular a support point, is provided.

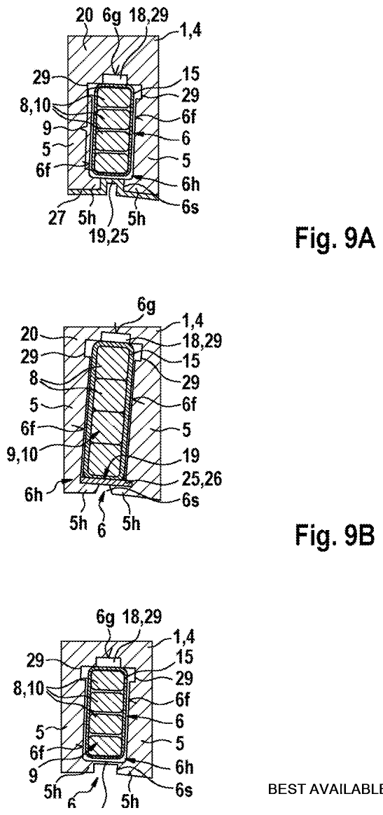

The respective bypass 18 in the slot base 6g can be formed according to FIGS. 9A, 9B, and 9C, for example, by one or two recesses 29 in the slot flanks 6 f at the foot of the stator teeth 5 or a recess 29 in the slot base 6g.

The stator slots 6 of the stator 1 are closed to seal the slot cooling paths 14 by means of at least one slot closure 25.

The stator slots 6 may have slot slots 6s in the slot head 6h. In each slot 6s, a strip-shaped slot closure 26, in particular a cover slider, can be provided as a separate element according to a first slot closure variant. Alternatively, according to a second slot closure variant, a single sleeve-shaped or tubular slot closure 27 can be designed as a separate element for closing all slots 6s.

Alternatively, according to a third slot closure variant, the slot closures 25 can each be formed by a metallic tooth head bridge 28 that is part of one of the laminations 7, connects tooth heads 5h of adjacent stator teeth 5, and in particular has reduced magnetic conductivity.

The reduced magnetic conductivity of the tooth head bridge 28 can be achieved, for example, by heat treatment or cold forming of the tooth head bridge 26.

The respective slot closure 25 has several barriers 19 spaced apart in the axial direction for the respective slot cooling path 14. The barriers 19 extend in particular to the conductor 8 or the conductor bundle 9. Between adjacent barriers 19 of the same stator slot 6, a passageway 18 extending on the axial direction is formed as a bypass 18 for the respective slot cooling path 14.

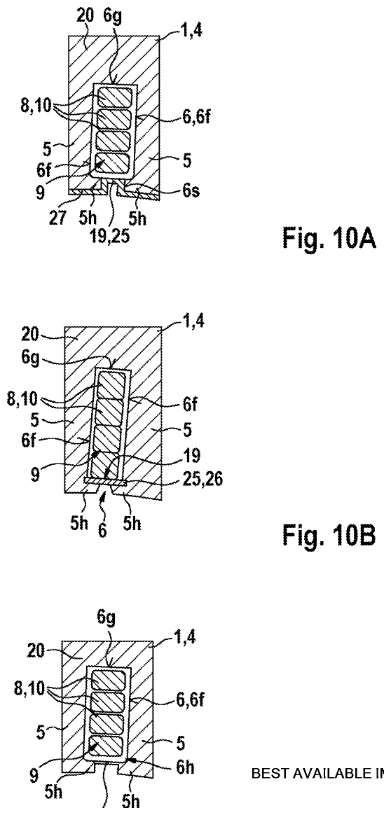

FIG. 10A, FIG. 10B, and FIG. 10C show one of the barriers 19 of the respective slot closure 25 for the three slot closure variants.

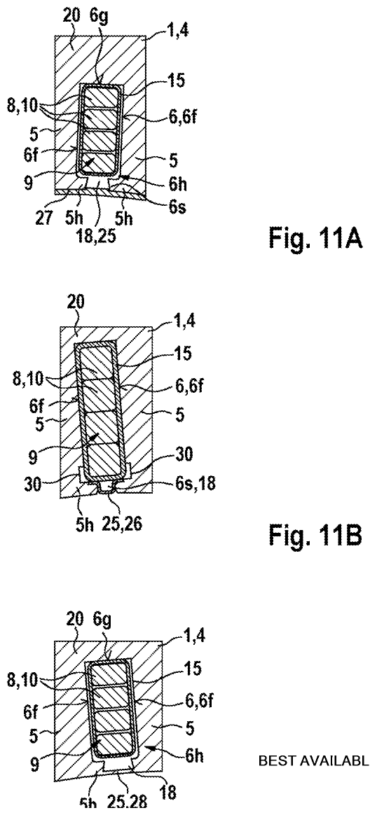

The respective bypass 18 in the slot head 6h can be formed according to the slot closure variants in FIG. 11A, FIG. 11B, and FIG. 11C by a recess in the slot closure 25, 26, 27, which is recessed relative to adjacent barriers 19 of the same stator slot 6. The recesses in the slot closure 25 can be, for example, a cutout, shaping, protrusion, or bead.

Alternatively or additionally, the respective bypass 18 in the slot head 6h according to FIG. 11B can be formed by one or two recesses 30 in the slot flanks 6f at the foot of a tooth head 6h of the stator teeth 6.

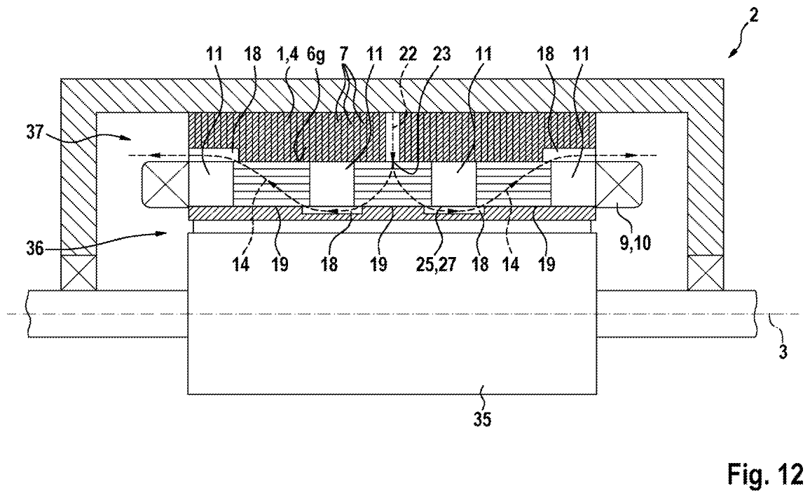

FIG. 12 shows an electric machine comprising a stator 1 and a rotor 35 according to the invention.

The rotor 35 is arranged in a cylindrical rotor space 36, and the stator 1 is arranged in a stator space 37 that annularly encloses the rotor space 36.

According to the invention, the stator space 37 and the rotor space 36 are not spatially separated.

1. A stator (1) of an electric machine (2) with a stator axis (3) and a stator laminated core (4) on which stator teeth (5) and stator slots (6) lying between the stator teeth (5) are formed and which comprises a plurality of laminations (7), wherein the stator slots (6) each extend in a radial direction with respect to the stator axis (3) between a slot base (6g) and a slot head (6h), wherein in the stator slots (6), a conductor bundle (9) comprising an individual conductor (8) or multiple conductors (8) is provided to form an electric stator winding (10), wherein a plurality of support points (11) which are spaced apart from each other in an axial direction with respect to the stator axis (3) are formed in each stator slot (6) to clamp the conductor (8) or conductor bundle (9) lying in the respective stator slot (6), wherein at least one slot gap (12) is provided between slot flanks (6f) of the respective stator slot (6) and the conductor (8) or conductor bundle (9) arranged in the stator slot (6), said slot gap forming a slot gap channel (13) extending in the axial direction, through which a cooling medium, can flow along a slot cooling path (14), wherein
the support points (11) are each formed by twisting individual or a plurality of laminations (7) of the stator laminated core (4),
at least one supply path (22) is formed in the stator laminated core (4), which is provided for supplying cooling medium to the slot cooling paths (14) and opens into the stator slots (6) via a respective slot inlet (23),
two slot cooling paths (14) extending in opposite directions are provided in each stator slot (6), starting from the respective slot inlet (23), which exit as a free jet at ends of the respective stator slot (6) via a slot outlet (24).

2. The stator according to claim 1, wherein the respective slot cooling path (14) is at least narrowed at the support points (11), wherein a bypass (18) is provided at each support point (11) to guide the cooling medium past the respective narrowed support point (11), wherein the bypasses (18) of the respective stator slot (6) are formed alternately in the slot base (6g) or in the slot head (6h) starting from the respective slot inlet (23) along the respective slot cooling path (14).

3. The stator according to claim 2, wherein first bypasses (18) of the respective stator slot (6), viewed from the respective slot inlet (23) in a flow direction, are provided in the slot head (6h).

4. The stator according to claim 1, wherein the respective slot inlet (23) opens into the slot base (6g) of the respective stator slot (6) in a central axial section of the respective stator slot (6).

5. The stator according to claim 1, wherein the respective slot inlet (23) in the respective stator slot (6) lies between two support points (11), whose axial distance (d) from each other is less than a distance (d) between other adjacent support points (11).

6. The stator according to claim 1, wherein
a. for all stator slots (6), an identical path of the slot cooling paths (14) is provided, or
b. for a first set (32.1) of stator slots (6), first slot cooling paths (14.1) are provided, and for a second set (32.2) of stator slots (6), second slot cooling paths (14.2) extending in an opposite radial direction are provided.

7. The stator according to claim 6, wherein the two slot cooling paths (14) extending in opposite directions for each stator slot (6) can be supplied with cooling medium by a common slot inlet (23) or by two separate slot inlets (23) separated from each other by one of the support points (11).

8. The stator according to claim 6, wherein the first slot cooling paths (14.1) of the first set (32.1) of stator slots (6) can be supplied with cooling medium via first slot inlets (23.1) and the second slot cooling paths (14.2) of the second set (32.2) of stator slots (6) can be supplied with cooling medium via second slot inlets (23.2), wherein an axial offset (X) is provided in the axial direction between the first and second slot inlets (23.1, 23.2).

9. The stator according to claim 1, wherein the stator slots (6) are closed by at least one slot closure (25) to seal the slot cooling paths (14), wherein
a. the stator slots (6) in the slot head (6h) have slot openings (6s), wherein a strip-shaped slot closure (26), is provided as a separate element in each slot opening (6s), or wherein a single sleeve-shaped or tubular slot closure (27) is configured as a separate element for closing all slot openings (6s), or
b. the slot closures (25) are each formed by a tooth head bridge (28) that is part of one of the laminations (7), connects tooth heads (5h) of adjacent stator teeth (5).

10. The stator according to claim 9, wherein the respective slot closure (25) comprises multiple barriers (19) spaced apart from each other in the axial direction for the respective slot cooling path (14), and wherein a passage as bypass (18) for the respective slot cooling path (14) is formed between adjacent barriers (19) of the same stator slot (6).

11. The stator according to claim 10, wherein the respective bypass (18) is formed in the slot head (6h) by
a. a recess in the slot closure (25) that is recessed relative to adjacent barriers (19), or
b. one or two recesses (30) in the slot flanks (6f) at the base of a tooth head (5h) of the stator teeth (5).

12. The stator according to claim 2, wherein
the respective bypass (18) is formed in the slot base (6g) by
a. one or two recesses (29) in the slot flanks (6f) at the base of the stator teeth (5), or
b. by a recess (29) in the slot base (6g).

13. An electric machine with a stator (1) according to claim 1 and with a rotor (35), wherein the rotor (35) is arranged in a cylindrical rotor space (36) and the stator (1) is arranged in a stator space (37) annularly surrounding the rotor space (36), wherein the stator space (37) and the rotor space (36) are not spatially separated.

14. The stator according to claim 1, wherein the multiple conductors (8), include a stack of flat wire conductors.

15. The stator according to claim 1, wherein the cooling medium is oil.

16. The stator according to claim 1, wherein the bypasses (18) make the slot cooling paths (14) meandering slot cooling paths (14).

17. The stator according to claim 4, wherein the respective slot inlet (23) opens into the slot base (6g) of the respective stator slot (6) in an axial center of the respective stator slot (6).

18. The stator according to claim 8, wherein the axial offset (X) is a support point (11).

19. The stator according to claim 9, wherein the tooth head bridge (28) has a reduced magnetic conductivity.

20. The stator according to claim 10, wherein the multiple barriers (19) extend to the conductor (8) or the conductor bundle (9).
